(19) United States
(12) Patent Application Publication
(10) Pub. No.: US 2019/0076857 A1
(43) Pub. Date: Mar. 14, 2019

(54) SIMPLIFIED AIRLESS SPRAY GUN

(71) Applicant: Wagner Spray Tech Corporation, Plymouth, MN (US)

(72) Inventor: Brian L. Fideler, Jordan, MN (US)

(73) Assignee: Wagner Spray Tech Corporation

(21) Appl. No.: 15/704,745

(22) Filed: Sep. 14, 2017

(51) Int. Cl. B05B 1/32; B05B 12/00

(52) U.S. Cl. CPC B05B 1/32; B05B 1/3013; B05B 12/002

(57) ABSTRACT

A spray gun is presented. The spray gun includes a fluid applicator configured to receive a pressurized liquid through an inlet and disperse the pressurized liquid through an outlet. The fluid applicator includes a body defining a fluid path. The fluid applicator includes a valve assembly including a first end portion opposite of a second end portion configured to be movable between a first position and a second position. The second end portion is configured to be in fluidic contact with the pressurized liquid at the first position. Both the first end portion and the second end portion are configured to be in fluidic contact with the pressurized liquid at the second position.

### BACKGROUND

Many spray guns include a liquid applicator with a trigger. Triggers on liquid applicators are often pressure actuated, for example, a user's hand or fingers can apply force to a trigger and, as a result of the applied force, paint, or another exemplary liquid, flows from an outlet of the liquid applicator. However, when a user releases pressure on the trigger, the outgoing flow ceases. For at least some liquid applicators, the applied pressure corresponds to a pressure of a liquid exiting the liquid applicator.

### SUMMARY

A spray gun is presented. The spray gun includes a fluid applicator configured to receive a pressurized liquid through an inlet and disperse the pressurized liquid through an outlet. The fluid applicator includes a body defining a fluid path. The fluid applicator includes a valve assembly including a first end portion opposite of a second end portion configured to be movable between a first position and a second position. The second end portion is configured to be in fluidic contact with the pressurized liquid at the first position. Both the first end portion and the second end portion are configured to be in fluidic contact with the pressurized liquid at the second position.

### BRIEF DESCRIPTION OF THE DRAWINGS

FIG. 1 is a diagrammatic view of a spray gun in accordance with an embodiment of the present invention.

FIG. 2 is an exploded view of a spray gun in accordance with an embodiment of the present invention.

FIG. 3 is a cross-sectional view of a spray gun in accordance with an embodiment of the present invention.

FIG. 4 is an exploded view of a fluid applicator in accordance with an embodiment of the present invention.

FIGS. 5A-5B are cross-sectional views of a fluid applicator in accordance with an embodiment of the present invention.

FIGS. 6A-6B are cross-sectional views of a fluid applicator in accordance with an embodiment of the present invention.

FIG. 7 is a flow diagram illustrating an operation of dispersing liquid in accordance with an embodiment of the present invention.

### DETAILED DESCRIPTION OF ILLUSTRATIVE EMBODIMENTS

In operation, spray guns require an application of pressure to actuate a trigger, which, in turn, drives a valve assembly towards an open, or second, position allowing for a dispersal of liquid. Alternatively, when a spray gun is not in use, a trigger is configured to maintain a non-actuated position effectively keeping a valve assembly in a closed, first, position to reduce a risk of accidental fluid discharge. However, during operation, this design causes user fatigue over a duration of a paint spraying operation as a user has to consistently apply pressure to the trigger to keep the valve assembly in the open position. Current attempts to offset the pressure exerting a force holding the valve open have included using a spring force to counter balance said pressure that will move the valve to a closed position when the trigger is released. However, a spray gun is desired that effectively reduces the pressure (holding the valve open) without necessitating a spring (to counter act the pressure force holding the valve open) proximate to the valve assembly. Some embodiments provided herein include a spray gun design that effectively reduces or eliminates the fluid pressure holding the valve assembly in the open position. Additionally, some embodiments herein allow for a simplified spray gun having fewer components and a smaller design compared to known spray guns. In turn, this leads to a reduced cost and/or weight borne by the end user.

Aspects of the present disclosure relate to spray guns, for example spray guns configured to dispense paint, coatings, textured material, plural components, etc. While the present disclosure is not necessarily limited to such applications, various aspects of the disclosure may be appreciated through a discussion of various examples, for example paint, in order to provide context.

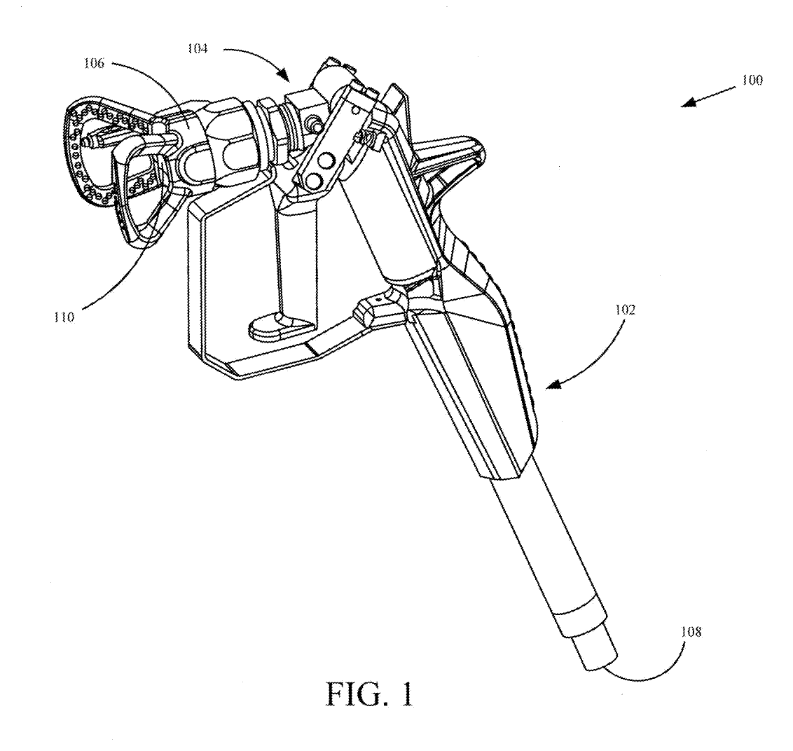

FIG. 1 is a diagrammatic view of a spray gun in accordance with an embodiment of the present invention. As illustratively shown, spray gun 100 includes a front end portion 106 configured to orient a dispersal of fluid in a particular direction, a fluid applicator 104 configured to receive a flow of pressurized liquid from an inlet 108 and disperse the flow of pressured liquid through an outlet 110, and a handle 102 configured to be held by an operator during operation of spray gun 100.

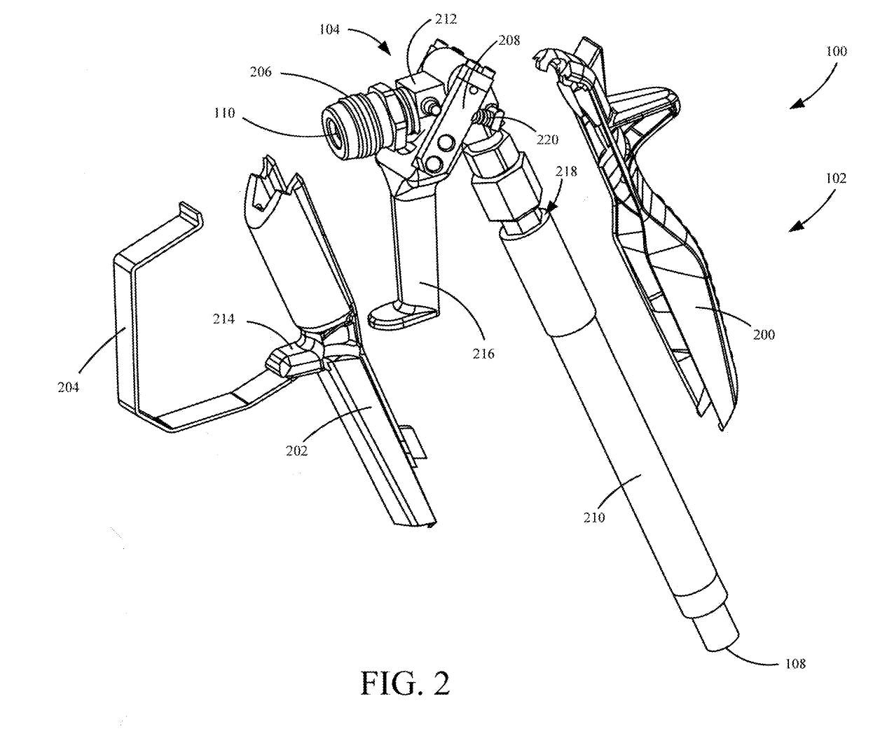

FIG. 2 is an exploded view of a spray gun in accordance with an embodiment of the present invention. Spray gun 100 includes a fluid applicator 104 that has a body 212, defining a fluid path, coupled to a receiving portion 210 having inlet 108. In one embodiment, body 212 is coupled to receiving portion 210 at a coupling point 218 using a threaded connection. However, other coupling mechanisms may be used in accordance with other embodiments. In operation, fluid applicator 104 receives a pressurized liquid from a pressurized liquid source through inlet 108 of receiving portion 210. The pressurized liquid then flows through receiving portion 210 and body 212 and is subsequently dispersed out of fluid applicator 104. Additionally, in one embodiment, fluid applicator 104 includes a diffuser 206 configured to reduce a velocity and increase a static pressure of a pressurized liquid as it is dispersed out of fluid applicator 104.

Fluid applicator 104 includes a trigger 216 coupled to body 212 using a coupling mechanism 208. Trigger 216 is configured to drive or otherwise actuate a valve assembly within body 212 between a first position and a second position. In one embodiment, as illustratively shown, when spray gun 100 is not in use, trigger 216 is biased towards a non-actuated position so that a valve assembly within body 212 remains in a first position preventing a dispersal of liquid from outlet 110. In one embodiment, trigger 216 is biased to the non-actuated position via a biasing member 220 configured to couple to body 212 and coupling mechanism 208. Upon applying a pressure to trigger 216, trigger 216 moves to the actuated position and simultaneously drives the valve assembly to a second position allowing for a dispersal of liquid from outlet 110. In one example, while the valve assembly is in the first position, pressurized liquid remains within body 212 and receiving portion 210 and is not dispersed as the valve assembly obstructs the pressurized liquid from outlet 110. By subsequently moving the valve assembly to the second position, the valve assembly does not obstruct outlet 110 and the pressurized liquid within body 212 and receiving portion 210 is able to be dispersed.

As illustratively shown, spray gun 100 includes handle 102 that, in one embodiment, includes a first housing 200 and a second housing 202 configured to be coupled together with fluid applicator 104. Second housing 202 includes a trigger guard 204 coupled to second housing 202 using a fastening mechanism 214. Trigger guard 204 is configured to prevent an inadvertent actuation of trigger 108. In one example, both first housing 200 and second housing 202 are configured to simultaneously couple to body 212 and receiving portion 210 of fluid applicator 104. However, in other embodiments, handle 102 is a singular piece configured to couple to fluid applicator 104.

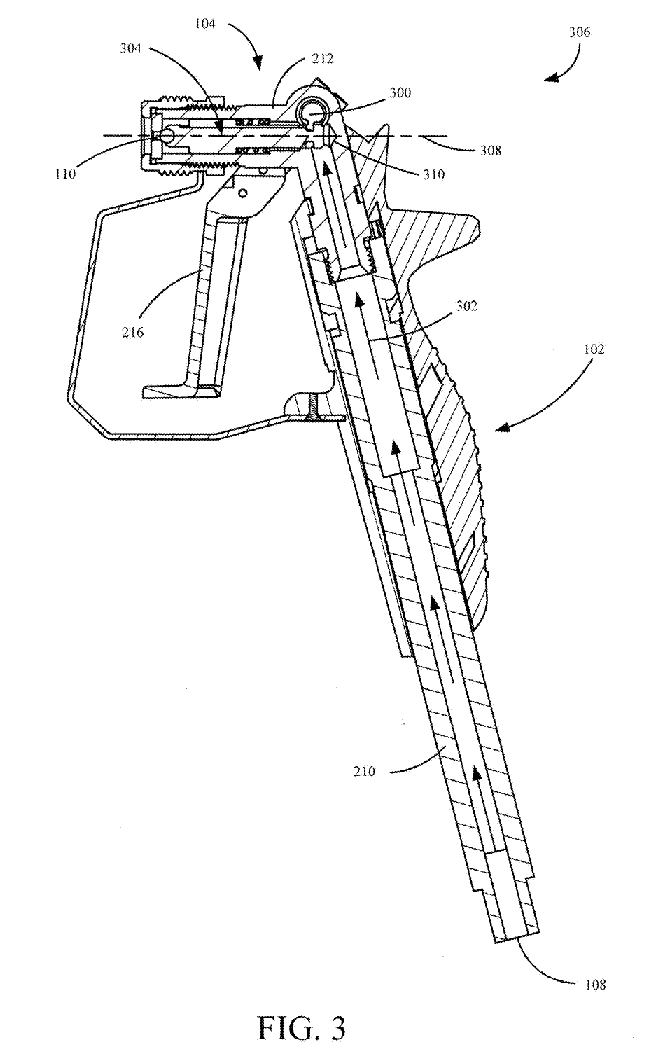

FIG. 3 is a cross-sectional view of a spray gun in accordance with an embodiment of the present invention. Spray gun 306 is similar to spray gun 100 and, as such, includes components numbered similarly. As illustratively shown, spray gun 306 includes fluid applicator 104 configured to receive pressurized fluid from a pressurized liquid source through inlet 108 of receiving portion 210. The pressurized fluid then travels along a flow path 302 through receiving portion 210 and body 212, and is configured to be dispersed through an outlet 110.

Fluid applicator 104 includes a valve assembly 304 within body 212 configured to move between a first position and a second position. The first position of valve assembly 304, as illustratively shown, obstructs a dispersal of pressurized liquid from outlet 110 of fluid applicator 104. Alternatively, moving valve assembly 304 to the second position includes moving valve assembly 304 laterally along axis 308 so that the pressurized fluid can be dispersed out of outlet 110 of fluid applicator 104.

Valve assembly 304 is coupled to an actuating mechanism 300 within body 212 of fluid applicator 104. Actuating mechanism 300 is configured to selectively move valve assembly 304 between the first and second positions based on an operator applying pressure to trigger 216, effectively moving trigger 216 from a non-actuated position, as illustratively shown, to an actuated position. In this example, trigger 216 is coupled to actuating mechanism 300 using a coupling mechanism, e.g. coupling mechanism 208 in FIG. 2.

In operation, upon applying a pressure to trigger 216, a force is subsequently generated and transferred through a coupling mechanism, e.g. coupling mechanism 208 as shown in FIG. 2, to actuating mechanism 300. Upon receiving the force, actuating mechanism 300 moves valve assembly 304 from a first position to a second position in order for a pressurized fluid to be dispersed out of outlet 110. However, in order to maintain a dispersal of pressurized liquid, valve assembly 304 must remain in the second position. As a result, this requires a constant pressure from a user to maintain trigger 216 in an actuated position. However, over a course of a liquid application process, this may cause user fatigue in maintaining an applied pressure to trigger 216. Specifically, as a pressurized fluid travels along flow path 302 and is dispersed out of outlet 110, the pressurized fluid acts against a second end portion, or rear seal portion and, as such, requires an elevated amount of pressure from a user to counterbalance the spring force required to close the valve upon trigger release.

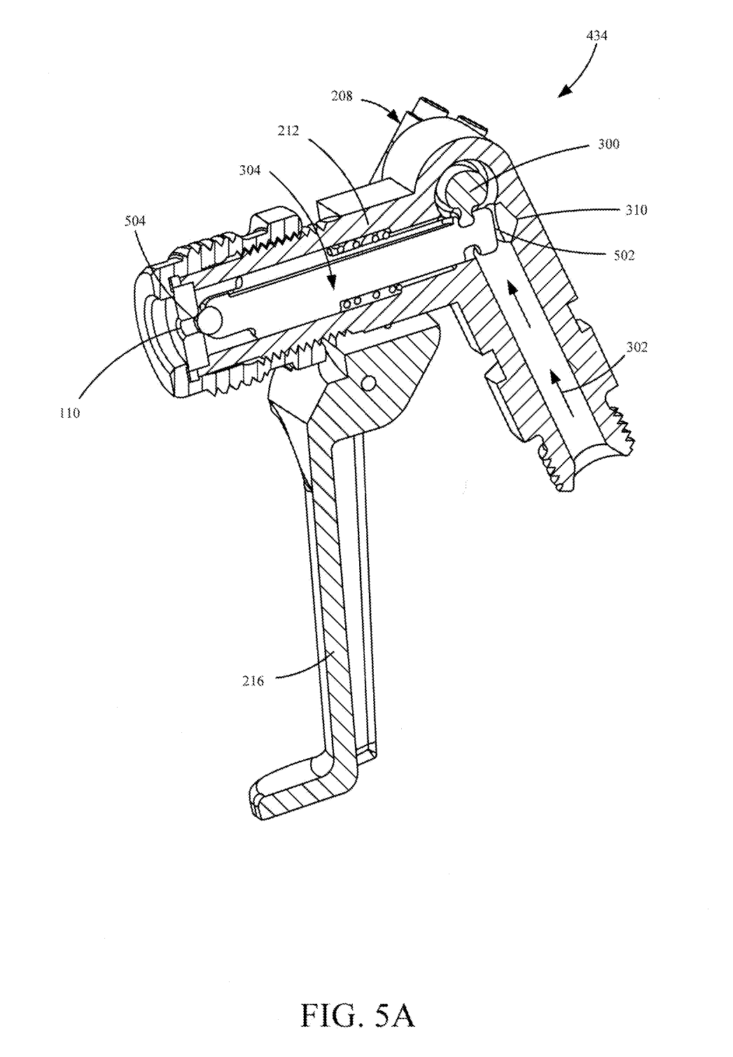

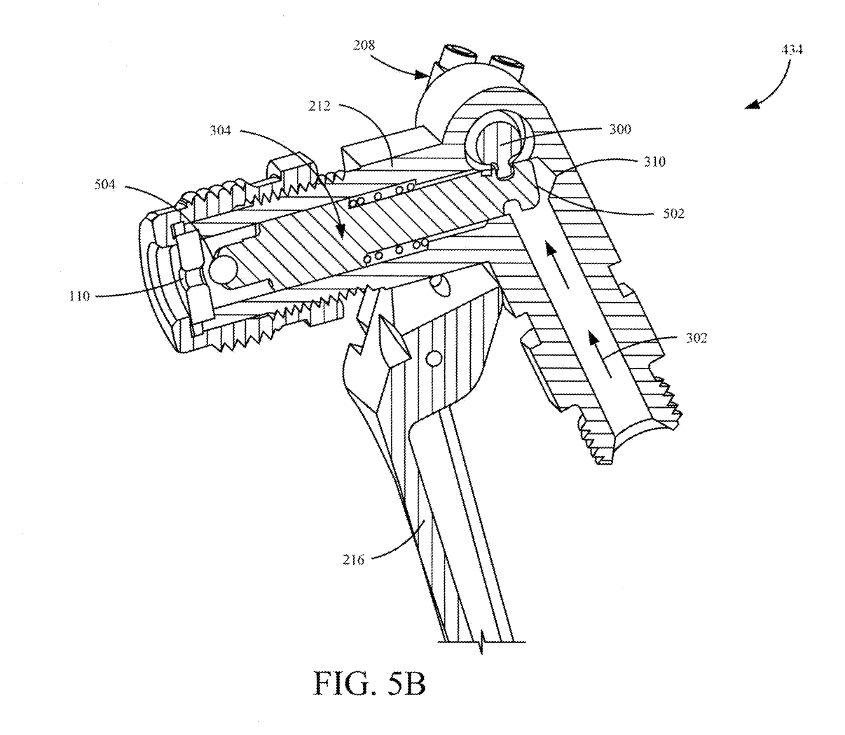

However, in accordance with an embodiment of the present invention, a configuration of flow path 302 allows for an alleviation of pressure required in maintaining valve assembly 304 in a second position, and thus, trigger 216 in an actuated position. For example, by receiving a pressurized liquid through inlet 108 located at a distal portion of spray gun 306, the pressurized liquid is configured to travel through a rear portion of body 212, through handle 102, and come into contact with a second end portion of valve assembly 304, as will be discussed in FIG. 5A-5B. Further, the pressurized liquid can travel in a notch 310 within body 212. By having a pressurized fluid come into contact with a second end portion of valve assembly 304, the pressurized fluid can counter a pressure placed on a first end portion, or obstruction portion, as the pressurized fluid is dispersed through outlet 110. In one example, an equal pressure is then placed on all sides of valve assembly 304 within the pressure vessel, which eliminates a pressure force acting to maintain valve assembly 304 in the second position. By effectively reducing or eliminating the pressure holding the valve assembly in the second, open, position, there is no need for a strong spring in accordance with the present invention, which, in turn, eliminates user fatigue in carrying out a liquid spraying application.

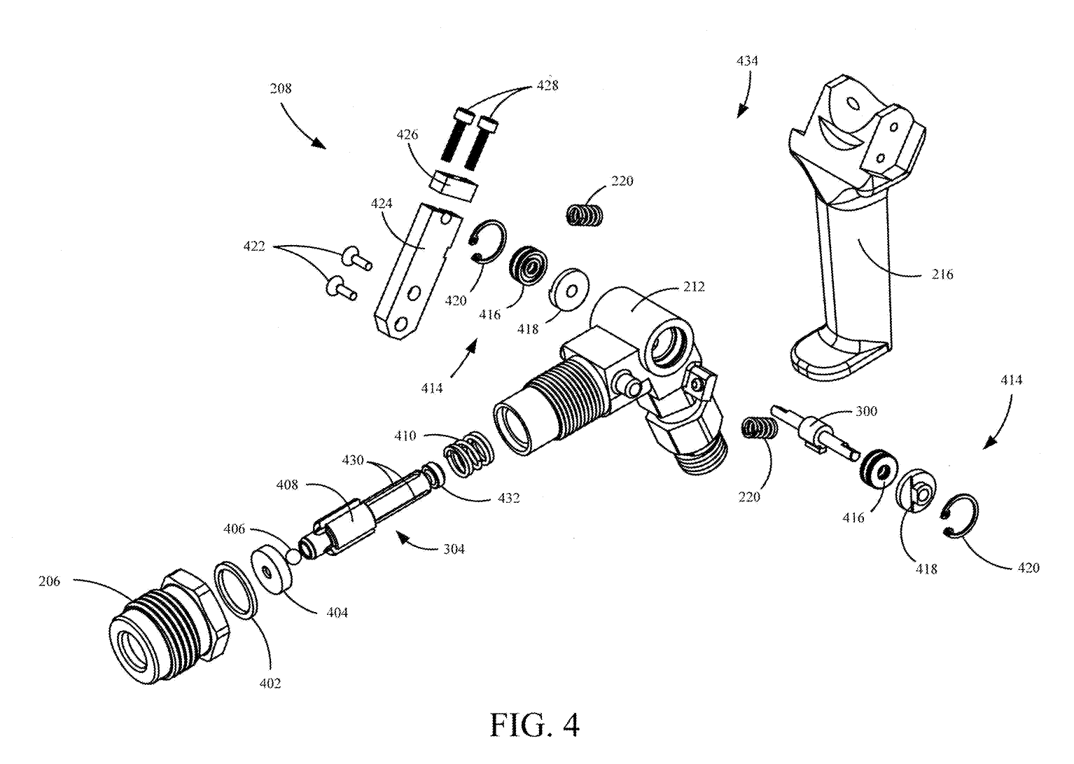

FIG. 4 illustrates an exploded view of a fluid applicator of a spray gun in accordance with an embodiment of the present invention. Fluid applicator 434 is similar to fluid applicator 104 and, as such, includes components numbered similarly. As illustratively shown, fluid applicator 434 includes diffuser 206, a gasket 402, a seat 404 and valve assembly 304.

Gasket 402 and seat 404 are configured to be housed within a diffuser 206-body 212 coupling and, along with valve assembly 304, while at a first position, obstruct pressurized fluid from being dispersed from an outlet. As illustratively shown, valve assembly 304 includes a blocking member 406, a guide 408 and a biasing member 410. Blocking member 406 is configured to couple to guide 408 and, while in a first position, sit against a central aperture of seat 404 serving as an obstruction for pressurized liquid. While in a second position, blocking member 406 and guide 408 are configured to move laterally so that blocking member 406 moves away from the central aperture of seat 404, allowing pressurized liquid to be dispersed through an outlet of fluid applicator 434. Biasing member 410 is coupled to guide 408 and is configured to be compressed between guide 408 and body 212 while blocking member 406 and guide 408 remain in the second position. In this embodiment, a biasing force is generated and acts on valve assembly 304 in the direction generally towards an outlet of fluid applicator 434. In one embodiment, biasing member 410 is configured to remove any friction within the system.

Guide 408 includes grooves 430 configured to receive a flow of pressurized liquid as the pressurized liquid is dispersed from fluid applicator 434. While two elongated grooves are illustratively shown, guide 408 can include any number of grooves 430. Further, guide 408 includes a radial groove 432 configured to couple to actuating mechanism 300. However, in other embodiments, guide 408 is able to couple to actuating mechanism 300 in a variety of ways.

As illustratively shown, fluid applicator 434 also includes actuating mechanism 300 and sealing mechanisms 414. Actuating mechanism 300 includes a protrusion configured to couple to radial groove 432 of valve assembly 304 and arms configured to couple to sealing mechanisms 414. Sealing mechanisms 414 include seals 416, bushings 418 and retainers 420 and are configured to prevent a leakage of pressurized liquid from body 212 of fluid applicator 434. Actuating mechanism 300 is a cam configured to receive a rotational force provided from trigger 216 and transform the rotational force into liner motion to selectively drive valve assembly 304 from a first position to a second position. Further, in one embodiment, actuating mechanism 300 is configured to be housed within a bore of body 212. Sealing mechanisms 414 are configured to couple to opposing sides of actuating mechanism 300 and are configured to provide a robust seal between body 212 and coupling mechanism 208. However, while it is illustratively shown that sealing mechanisms 414 include seals 416, bushings 418 and retainers 420, it is expressly contemplated that other sealing components can be used to ensure that pressurized liquid does not leak out of body 212 during operation.

Fluid applicator 434 includes a coupling mechanism 208 that includes an arm 424, a top 426 and fastening members 422 and 428. Coupling mechanism 208 is configured to couple trigger 216 to actuating mechanism 300. In operation, trigger 216 is coupled to arm 424 of coupling mechanism 208 using fastening members 422. Further, in one embodiment, an arm of actuating mechanism 300 is configured to couple to an arm 424-top 426 coupling of coupling mechanism 208 using fastening members 428. While it is illustratively shown that coupling mechanism 208 includes arm 424 and top 426 as separate pieces, it is expressly contemplated that arm 424 and top 426 can also be a singular piece in some embodiments. Additionally, while it is illustratively shown that actuating mechanism 300 is separate from, and configured to couple to valve assembly 304, in other embodiments, actuating mechanism 300 and valve assembly 304 are a singular piece configured move between a first position and a second position within body 212.

FIGS. 5A-5B are cross-sectional views of a fluid applicator in accordance with an embodiment of the present invention. As illustratively shown in FIGS. 5A-5B, fluid applicator 434 includes valve assembly 304 and actuating mechanism 300 within body 212 of fluid applicator 434. As illustratively shown in FIG. 5A, when valve assembly 304 is in a first position and trigger 216 is in a non-actuated position, outlet 110 is obstructed. However, while valve assembly 304 is in the first position, a second end portion 502 of valve assembly 304 is configured to come into fluidic contact with the pressurized fluid upon receiving the pressurized fluid from flow path 302. Further, the pressurized fluid may contact grooves of valve assembly 304. Additionally, the pressurized fluid is also configured to come into contact with a notch 310 proximate to second end portion 502 of valve assembly 304. However, in other embodiments, notch 310 can include a groove or any other cavity configured to receive the pressurized fluid.

Once valve assembly 304 is moved to a second position through the movement of trigger 216 to an actuated position, as illustratively shown in FIG. 5B, a first end portion 504 is configured to come into fluidic contact with the pressurized fluid as the pressurized fluid flows along grooves 430 of guide 408 and is subsequently dispersed from outlet 110. In one embodiment, an equal pressure is then placed on all sides of valve assembly 304 within a pressure vessel, eliminating a pressure force acting to maintain valve assembly 304 at the second position within the pressure vessel. This eliminates a need for a strong spring which, in turn, removes or eliminates a pressure required in maintaining a trigger at an actuated position as illustratively shown in FIG. 5B.

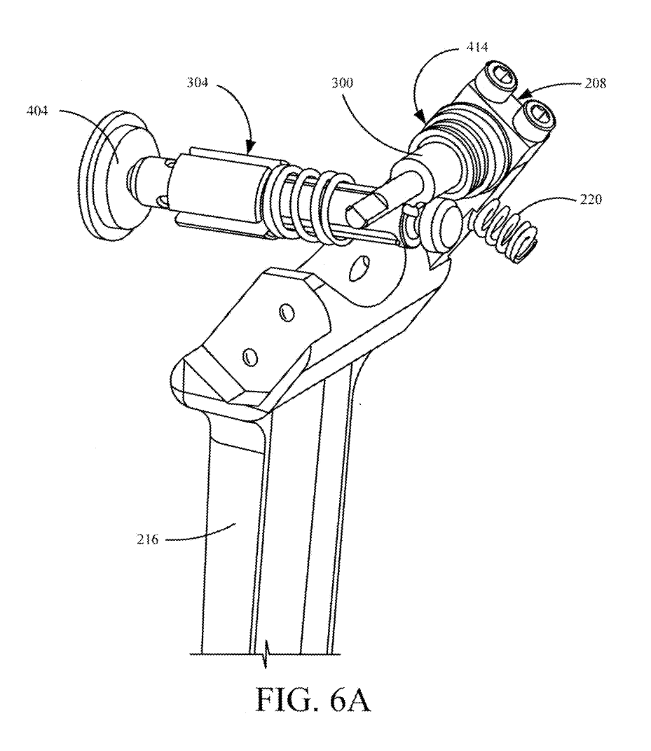

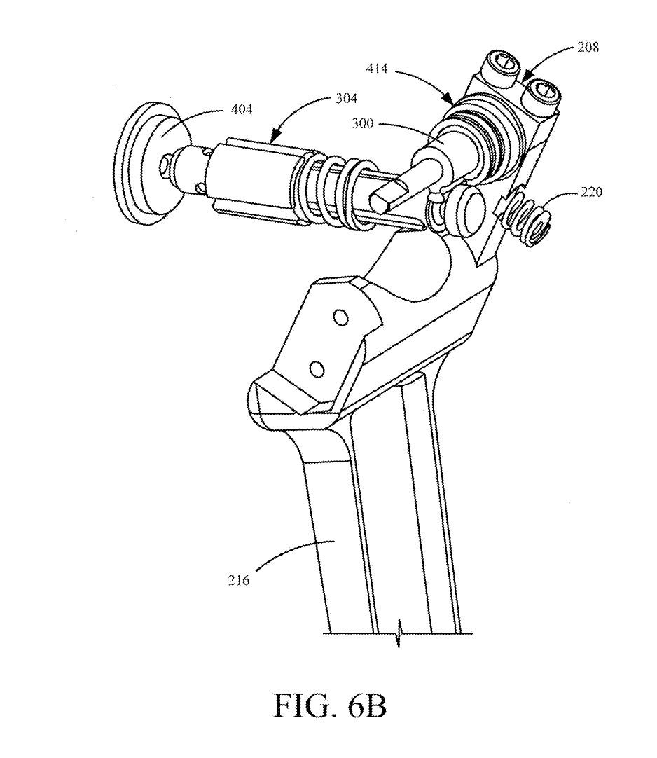

FIGS. 6A-6B are cross-sectional views of a fluid applicator in accordance with an embodiment of the present invention. As illustratively shown in FIG. 6A, valve assembly 304 is coupled to actuating mechanism 300 while sealing mechanism 414 provides a robust seal between actuating mechanism 300 and coupling mechanism 208. While in the first position, valve assembly 304 illustratively blocks a central aperture of seat 404 so that a pressurized liquid is not dispersed from an outlet. Alternatively, FIG. 6B illustratively shows valve assembly 304 in a second position that allows pressurized fluid to disperse from an outlet.

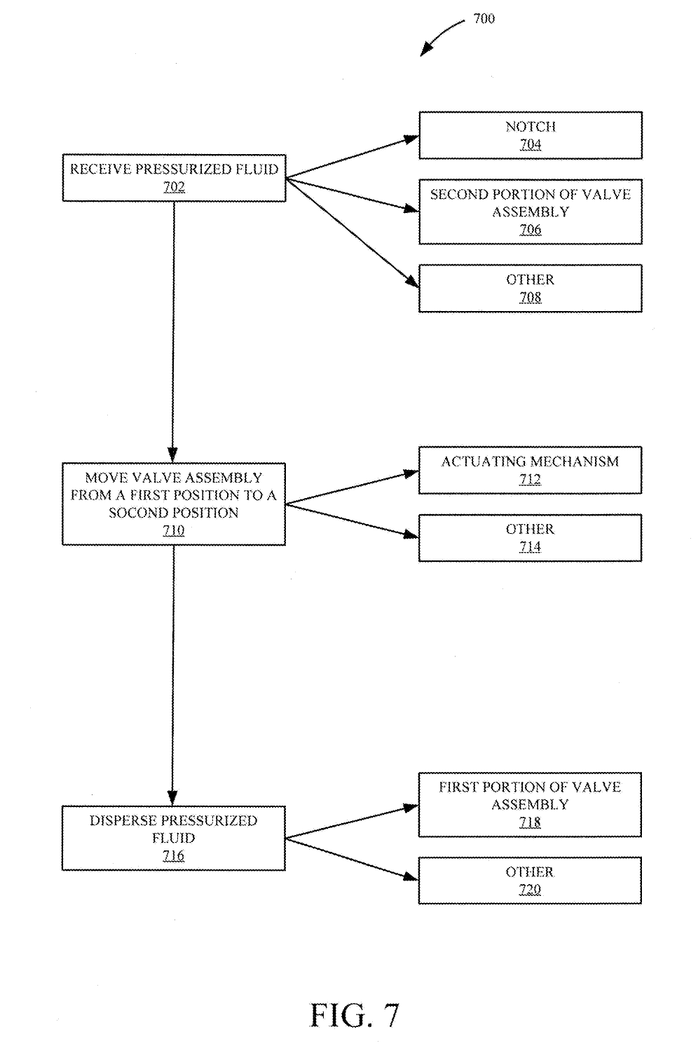

FIG. 7 is a flow diagram illustrating an operation of dispersing liquid in accordance with an embodiment of the present invention. Method 700 begins at block 702 when pressurized fluid is received. This includes a notch within a fluid applicator receiving the pressurized fluid as indicated in block 704. Alternatively, this also may include a second portion of a valve assembly receiving pressurized fluid as indicated in block 706. However, other sections of a spray gun may receive pressurized fluid as indicated in block 708.

Method then proceeds to block 710 where a valve assembly is moved from a first position to a second position. The valve assembly is moved using an actuating mechanism as indicated in block 712. However, other mechanisms can be used to move a valve assembly between a first and a second position as indicated in block 714.

Method then turns to block 716 where the pressurized fluid is dispersed out of an outlet. In one embodiment, this includes a first portion of a valve assembly coming into contact with the pressurized fluid as indicated in block 718. However, other portions of a spray gun may come into contact with the pressurized fluid as the pressurized fluid is dispersed as indicated in block 720.

Although the present invention has been described with reference to preferred embodiments, workers skilled in the art will recognize that changes may be made in form and detail without departing from the spirit and scope of the invention.

1. A spray gun comprising:
a fluid applicator configured to receive a pressurized liquid through an inlet and disperse the pressurized liquid through an outlet, comprising:
a body defining a fluid path;
a valve assembly comprising a first end portion opposite of a second end portion configured to be movable between a first position and a second position, wherein the second end portion is configured to be in fluidic contact with the pressurized liquid at the first position, and both the first end portion and the second end portion are configured to be in fluidic contact with the pressurized liquid at the second position; and
an actuating mechanism coupled to a lateral portion of the valve assembly and configured to selectively move the valve assembly between the first position and the second position.

2. The spray gun of claim 1, wherein the first end portion of the valve assembly comprises a portion of a blocking member configured to contact a seat when the valve assembly is in the first position.

3. The spray gun of claim 2, wherein the lateral portion is disposed on the second end portion of the valve assembly.

4. The spray gun of claim 3, wherein the lateral portion is disposed opposite of the blocking member.

5. The spray gun of claim 4, wherein the fluid applicator further comprises:
a trigger; and
a coupling mechanism configured to couple the trigger to the actuating mechanism, wherein the trigger is configured to drive the movement of the valve assembly between the first position and the second position.

6. The spray gun of claim 5, wherein the actuating mechanism is configured to transfer rotary motion received from the coupling mechanism into liner motion to selectively move the valve assembly between the first position and the second position.

7. The spray gun of claim 1, wherein the body comprises a notch proximate to the second end portion of the valve assembly.

8. The spray gun of claim 1, wherein the valve assembly obstructs the pressurized liquid at the first position and allows for the pressurized liquid to be dispersed at the second position.

9. (canceled)

10. The spray gun of claim 1, wherein the fluid applicator further comprises:
a diffuser configured to reduce a velocity and increase a static pressure of the pressurized liquid.

11. The spray gun of claim 1, further comprising:
a front end portion coupled to the fluid applicator configured to orient the pressurized liquid in a predefined orientation.

12. The spray gun of claim 1, wherein the handle comprises a first housing and a second housing configured to couple to the receiving portion and the body simultaneously.

13. The spray gun of claim 12, wherein the body is configured to couple to the receiving portion at a coupling point using a threaded connection.

14. The spray gun of claim 1, wherein the actuating mechanism is coupled to a lateral side of the second end portion.

15. The spray gun of claim 14, wherein the fluid applicator further comprises:
a trigger movable between a non-actuated and an actuated position; and
a coupling mechanism configured to couple the trigger to the actuating mechanism, wherein the non-actuated position selectively keeps the valve assembly in the first position and the actuated position selectively moves the valve assembly to the second position.

16. The spray gun of claim 15, wherein the valve assembly obstructs the pressurized liquid at the first position and allows for the pressurized liquid to be dispersed at the second position.

17. The spray gun of claim 15, wherein the fluid applicator further comprises:
a seal between the actuating mechanism and the coupling mechanism.

18. A spray gun comprising:
a fluid applicator configured to receive the pressurized liquid through an inlet and dispense the pressurized liquid through an outlet, comprising:
a body defining a fluid path to the outlet;
a valve assembly coupled to the body comprising a first end portion opposite of a second end portion configured to be movable between a first position and a second position, wherein the second end portion is configured to be in fluidic contact with the pressurized liquid at the first position and both the first end portion and the second end portion are configured to be in fluidic contact with the pressurized liquid at the second position;
an actuating mechanism configured to couple to a lateral side of the second end portion within the body and move the valve assembly between the first position and the second position; and
a coupling mechanism configured to simultaneously couple to a trigger and the actuating mechanism.

19. The spray gun assembly of claim 18, wherein the trigger is configured to be selectively moveable between an actuated position and a non-actuated position, wherein moving the trigger from the non-actuated position to the actuated position drives movement of the valve assembly from the first position to the second position.

20. The spray gun assembly of claim 18, wherein the actuating mechanism comprises a cam configured to transfer a rotary motion into a linear motion to move the valve assembly between the first position and the second position.
